(19) United States
(12) Patent Application Publication
(10) Pub. No.: US 2026/0095280 A1
(43) Pub. Date: Apr. 2, 2026

(54) TECHNOLOGIES FOR COHERENT JOINT TRANSMISSION CODEBOOK

(71) Applicant: Apple Inc., Cupertino, CA (US)

(72) Inventors: Haitong Sun, Saratoga, CA (US); Ankit Bhamri, Haar (DE); Chunxuan Ye, San Diego, CA (US); Dawei Zhang, Saratoga, CA (US); Huaning Niu, San Jose, CA (US); Oghenekome Oteri, San Diego, CA (US); Wei Zeng, Saratoga, CA (US); Xiang Cheng, Campbell, CA (US)

(73) Assignee: Apple Inc., Cupertino, CA (US)

(21) Appl. No.: 19/309,042

(22) Filed: Aug. 25, 2025

Related U.S. Application Data
(60) Provisional application No. 63/700,501, filed on Sep. 27, 2024.

(51) Int. Cl. H04L 5/00; H04B 7/06

(52) U.S. Cl. CPC H04L 5/0035; H04B 7/0626; H04L 5/0051

(57) ABSTRACT

The present application relates to devices and components including apparatuses, systems, and methods for coherent joint transmission (CJT) codebook reporting. For example, techniques are described for determination of CJT codebook feedback with phase offset compensation. Additionally, techniques are described for associating an offset report of phase, frequency, and/or time offset with a CJT codebook report.

### CROSS-REFERENCE TO RELATED APPLICATION

This application claims priority to U.S. Provisional Ser. No. 63/700,501, entitled “TECHNOLOGIES FOR COHERENT JOINT TRANSMISSION CODEBOOK,” filed on Sep. 27, 2024, which is herein incorporated by reference in its entirety for all purposes.

### TECHNICAL FIELD

This application relates generally to communication networks and, in particular, to technologies for coherent joint codebook reporting.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example of coherent joint transmission codebook reporting in accordance with some embodiments.

FIG. 3 illustrates an example radio resource control (RRC) configuration in accordance with some embodiments.

FIG. 4 illustrates an example timeline of communications by a user equipment (UE) in accordance with some embodiments.

FIG. 5 illustrates another example timeline of communications by a UE in accordance with some embodiments.

FIG. 6 illustrates another example timeline of communications by a UE in accordance with some embodiments.

FIG. 7 illustrates an operation flow/algorithmic structure in accordance with some embodiments.

FIG. 8 illustrates another operation flow/algorithmic structure in accordance with some embodiments.

FIG. 9 illustrates another operation flow/algorithmic structure in accordance with some embodiments.

FIG. 10 illustrates a user equipment in accordance with some embodiments.

FIG. 11 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A. ”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

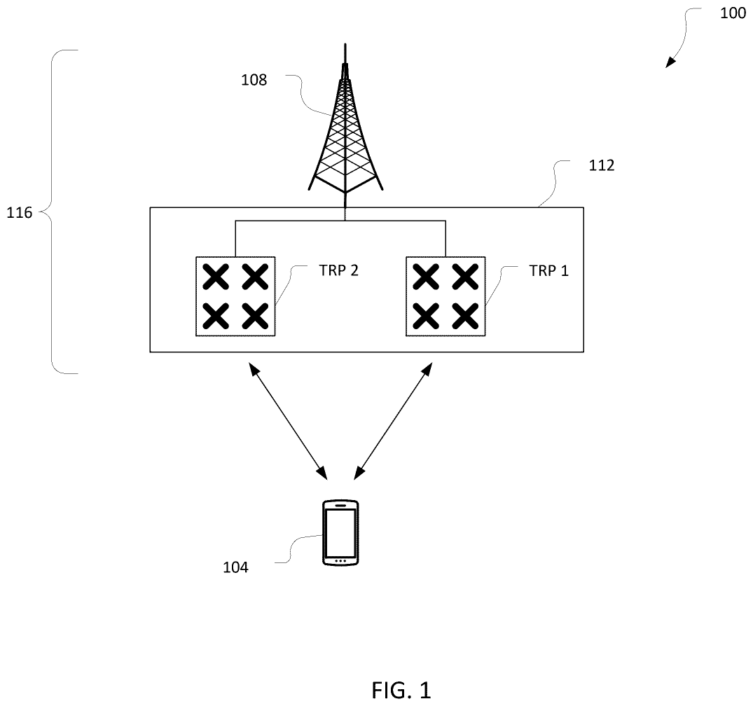

FIG. 1 illustrates a network environment 100 in accordance with some embodiments. The network environment 100 may include a UE 104 and a base station 108. The base station 108 may be coupled with a plurality of transmission-reception points (TRPs) 112 to provide one or more wireless access cells through which the UE 104 may communicate. As shown, the base station 108 may be coupled with two TRPs 112, e.g., TRP 1 and TRP 2. The base station 108 may use the TRPs 112 to provide geographically distributed points of transmission/reception to increase cell coverage and spatial diversity. Each of the TRPs may include a single TRP or a group of TRPs that are generally controlled as a single TRP.

While FIG. 1 illustrates the base station 108 coupled with the two TRPs directly, in other embodiments, more than one base station may be coupled with the two TRPs and the base stations may communicate with one other over a backhaul link to coordinate communications with the UE 104. The base station 108 and TRPs 112 may be collectively referred to as an access node 116.

The access node 116 may provide an air interface compatible with 3GPP technical specifications, such as those that define Fifth Generation (5G) new radio (NR) or later system standards. Depending on the technology, the base station 108 may be referred to as an eNB, gNB, an ng-NB, etc. The access node 116 may provide the UE 104 access to other networks, for example, a core network, a data network, etc.

Operations described herein as performed by a device (for example, UE 104 base station 108, TRPs 112, and/or access node 116) may be fully, substantially, or partially performed by processing circuitry implemented on the device. Additionally, operations described herein as performed by “the network” may be performed by a device of the access network (e.g., base station 108 and/or TRPs 112), a device of the core network, and/or components thereof.

The access node 116 may control the uplink and downlink operation through the physical (PHY) layer and media access control (MAC) layer. The configuration information may be provided to the UE 104 by the RRC layer.

The UE 104 and/or access node 116 may support multi-TRP (also referred to as mTRP) operation, in which the UE 104 communicates with multiple TRPs 112. The multi-TRP operation may be single-downlink control information (DCI) in which one DCI is used to schedule uplink or downlink transmissions with respect to more than one TRP. For example, as shown, TRP 1 may send DCI to the UE 104 that schedules uplink/downlink channel transmissions with respect to both the TRP 1 and the TRP 2. Alternatively, the multi-TRP operation may be multi-DCI in which separate DCIs are used to schedule uplink or downlink transmissions for respective TRPs. For example, TRP 1 may send a first DCI to the UE 104 that schedules uplink/downlink channel transmissions with respect to TRP 1 and TRP 2 may send a second DCI to the UE 104 that schedules uplink/downlink channel transmissions with respect to TRP 2.

In 3GPP NR Release (Rel)-15, multi-TRP operation is supported in transparent mode. Starting with Rel-16, explicit multi-TRP operation is supported. For example, Rel-16 supports five single-DCI multi-TRP non-coherent joint transmission (NCJT) schemes for physical downlink shared channel (PDSCH). The five schemes include one spatial domain multiplexing (SDM) scheme, two frequency domain multiplexing (FDM) schemes, and two time domain multiplexing (TDM) schemes. Additionally, multi-DCI multi-TRP is supported for both PDSCH and physical uplink shared channel (PUSCH).

In Rel-17, support for single-DCI multi-TRP TDM for PUSCH and physical uplink control channel (PUCCH) is added. For physical downlink control channel (PDCCH), two single frequency network (SFN) schemes and one PDCCH repetition scheme are supported. Additionally, two SFN schemes are supported for PDSCH.

In Rel-18, support for single-DCI multi-TRP coherent joint transmission (CJT) is added for PDSCH. For PUSCH, simultaneous transmission across multiple panels (STxMP) schemes are supported. The STxMP schemes include single-DCI SFN, single-DCI SDM, and multi-DCI. Additionally, a single-DCI SFN STxMP scheme is supported for PUCCH.

In some instances, the network may use maximum ratio transmission (MRT) for multi-TRP transmissions. In MRT, the beamforming weights of different TRPs may be adjusted (e.g., based on channel conditions) to improve (e.g., maximize) the signal-to-noise ratio in the combined transmission.

Multi-TRP CJT operation may require synchronization between antenna elements of different TRPs to maintain coherency. If coherency can be maintained, multi-TRP CJT has the potential to provide better performance compared to NCJT. However, different TRPs may experience different offsets/drifts in time, frequency, and phase, e.g., due to the location and/or movement of the UE, the hardware implementation of the TRP, and/or other factors.

The UE may measure the time, frequency, and/or phase offset between different TRPs and may report measurement information to the network to enable synchronization between the TRPs (e.g., to maintain coherency). The UE reporting may be particularly beneficial with CJT deployments with non-ideal synchronization and backhaul between the TRPs. The measurements may be performed on reference signals (e.g., channel state information—reference signals (CSI-RSs)) transmitted by the respective TRPs. In some instances, the UE may perform aperiodic reporting of the measurement information on PUSCH (e.g., the report may be triggered by a DCI).

The UE may additionally or alternatively determine a CJT codebook (also referred to as CJT codebook feedback) for CJT communication and report the CJT codebook to the network. The CJT codebook may be a Type II codebook specified in 3GPP TS38.214, Section 5.2.2.2.8, V18.3.0 (July 3, 2024). The CJT codebook may be determined based on the reference signals (e.g., CSI-RSs) transmitted by the TRPs. The CJT codebook may include precoding information, such as a precoding matrix and/or precoding matrix indicator (PMI), that the UE suggests to the network for the CJT transmission. The CJT codebook report may be aperiodic, e.g., triggered by a DCI.

Various embodiments herein provide techniques related to determination of CJT codebook feedback with time, frequency, and/or phase offset compensation. Additionally, embodiments provide techniques for associating an offset report of phase, frequency, and/or time offset with a CJT codebook report.

### Subband Phase Offset Reporting

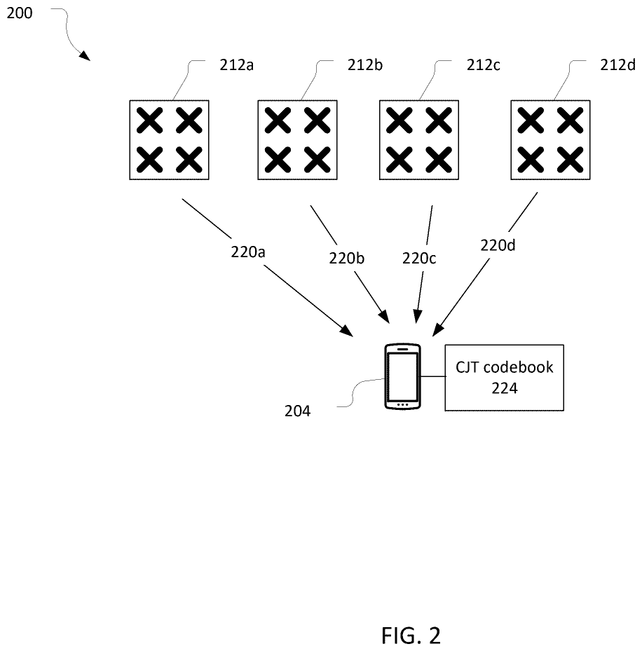

FIG. 2 illustrates another network environment 200 in accordance with various embodiments. Aspects of the network environment 200 may correspond to the network environment 100.

The network environment 200 may include a UE 204 and multiple TRPs 212a-d. The UE 204 may receive reference signals 220a-d (e.g., CSI-RS) from the respective TRPs 212a-d. The UE 204 may generate a CJT codebook 224 (e.g., a Type II CJT codebook) based on the reference signals 220a-d, and may transmit the CJT codebook 224 to the network. For example, the UE 204 may transmit the CJT codebook 224 in a channel state information (CSI) report (e.g., transmitted in a physical uplink shared channel (PUSCH)).

In various embodiments, the UE may determine a compensation (e.g., offset values, such as a time offset, frequency offset, and/or phase offset) for the respective TRPs. The UE 204 may calculate the CJT codebook 224 based on the respective compensations. For example, the UE 204 may apply offset values to the respective reference signals 220a-d used to calculate the CJT codebook 224 to provide compensated reference signals. The UE 204 may perform a CJT codebook calculation on the compensated reference signals to generate the CJT codebook feedback. The offset values may be applied in the time domain and/or the frequency domain. The CJT codebook 224 with compensation may be referred to herein as an enhanced CJT codebook.

In some embodiments, the UE 204 may perform one or more measurements associated with the respective TRPs 212a-d, such as one or more measurements of a time delay, a frequency offset, and/or a phase offset. In some embodiments, the one or more measurements may be performed on the reference signals 220a-d (e.g., on other reference signal resources/occasions than are used to calculate the CJT codebook 224).

The UE 204 may report the one or more measurements to the network. In some embodiments, the UE 204 may determine the compensation for the respective TRP 212a-d based on the one or more measurements for the TRP 212a-d. For example, the UE 204 may apply the measured time, frequency, and/or phase offset for the respective TRPs.

In other embodiments, the network (e.g., access node 116 and/or base station 108) may configure the compensation for the UE. For example, the network may determine the compensation based on the measurement report from the UE and/or other measurements performed or obtained by the network.

In some embodiments, the compensation may include a time delay compensation. For example, the UE 204 may assume a delay compensation of δₜⁿ for TRP n (n =0, 1, . . . N_{TRP} −1, where N_{TRP} is the number of TRPs.). The UE 204 may apply the delay compensation to the CSI-RS resource transmitted from TRP n when calculating the CJT codebook feedback. The time domain delay δₜⁿ may be equivalent to a phase ramp in the frequency domain. Accordingly, when performing a calculation in the frequency domain (e.g., for the CJT codebook), the UE 204 may apply a frequency domain phase ramp compensation.

In some embodiments, the compensation may include a frequency offset compensation. For example, the UE 204 may assume a frequency offset compensation of δ_{f}ⁿ for TRP n (n=0, 1, . . . N_{TRP} −1). The UE 204 may apply the frequency offset to the CSI-RS resource transmitted from TRP n when calculating the CJT codebook feedback.

In one example, the frequency offset compensation may be applied as a phase compensation, e.g., a phase compensation of 2π·δ_{f}_{ⁿ}ₜ·(t₂−t₁ⁿ) for TRP n when calculating the CJT codebook feedback, where t₁ⁿ is a time at which the CSI-RS resource is transmitted by TRP n and t₂ is a time of CJT codebook feedback (e.g., the time when the CJT codebook feedback is transmitted).

In another example, when the CSI-RS resource transmitted from TRP n is sampled in the time domain (e.g., before converting the sample to the frequency domain for the CJT codebook calculation), the time domain samples may be compensated by δ_{f}ⁿ frequency offset. For example, e^{-j2πδ}_{f}_{ⁿ}ₜ may be applied (multiplied) to the time domain sample at sampling time t.

In some embodiments, the compensation may include a phase offset compensation. For example, the UE 204 may assume a phase offset compensation of δₚⁿ for TRP n (n=0, 1, . . . N_{TRP} −1). The UE 204 may apply the phase offset to the CSI-RS resource transmitted from TRP n when calculating the CJT codebook feedback.

In some embodiments, the phase offset compensation may be different for different subbands in the frequency domain. For example, the phase offset compensation may be (δₚⁿ)ᵢ for the i^{th} frequency subband for TRP n. The UE 204 may apply the phase offset (δₚⁿ)ᵢ to the CSI-RS resource transmitted from TRP n for the i^{th} frequency subband when calculating the CJT codebook feedback.

In some embodiments, the enhanced CJT codebook with compensation (for time, frequency, and/or phase offset) may be supported for aperiodic channel state information (CSI) on physical uplink shared channel (PUSCH). The enhanced CJT codebook with compensation may not be supported for semi-persistent or periodic CSI.

In other embodiments, the enhanced CJT codebook with compensation may be supported for both aperiodic and semi-persistent CSI on PUSCH.

In some embodiments, the channel measurement resource (CMR) used for calculation of the enhanced CJT codebook with compensation may support aperiodic CSI-RS. Semi-persistent and periodic CSI-RS may not be supported for the CMR. In other embodiments, aperiodic and semi-persistent CSI-RS may be supported for the CMR, and periodic CSI-RS may not be supported. In other embodiments, aperiodic, semi-persistent, and periodic CSI-RS may all be supported for the CMR.

As discussed above, in some embodiments, the UE may receive configuration information from the network to configure the compensation (e.g., delay offset, frequency offset, and/or phase offset compensation) to apply for CJT codebook calculation. For example, the configuration information may explicitly configure a delay compensation of δₜⁿ for TRP n, a frequency offset compensation δ_{f}ⁿ for TRP n, and/or a phase offset compensation of δₚⁿ or (δₚⁿ)ᵢ for TRP n. In some embodiments, the configuration information may be included in a CSI report configuration (e.g., radio resource control (RRC) configuration CSI-ReportConfig). In other embodiments, the configuration information may be included in an aperiodic CSI association (e.g., RRC configuration CSI-AssociatedReportConfigInfo).

The configured offset values may correspond to offset values that the UE previously reported in an offset report. Receiving the configuration information with the offset values from the network may enable the UE to discard the offset values after they are reported to the network rather than storing the offset values for potential later use.

In some embodiments, the network may configure the UE to report the time, frequency, and/or phase offset measurements for the TRPs together with the enhanced CJT codebook. For example, the network may trigger a CSI aperiodic trigger state (CSI-AperiodicTrigger State) to associate a time, frequency, and/or phase offset report and a CJT codebook report. The network may transmit a DCI to the UE that includes the CSI aperiodic trigger state to trigger both the time, frequency, and/or phase offset report and the CJT codebook report.

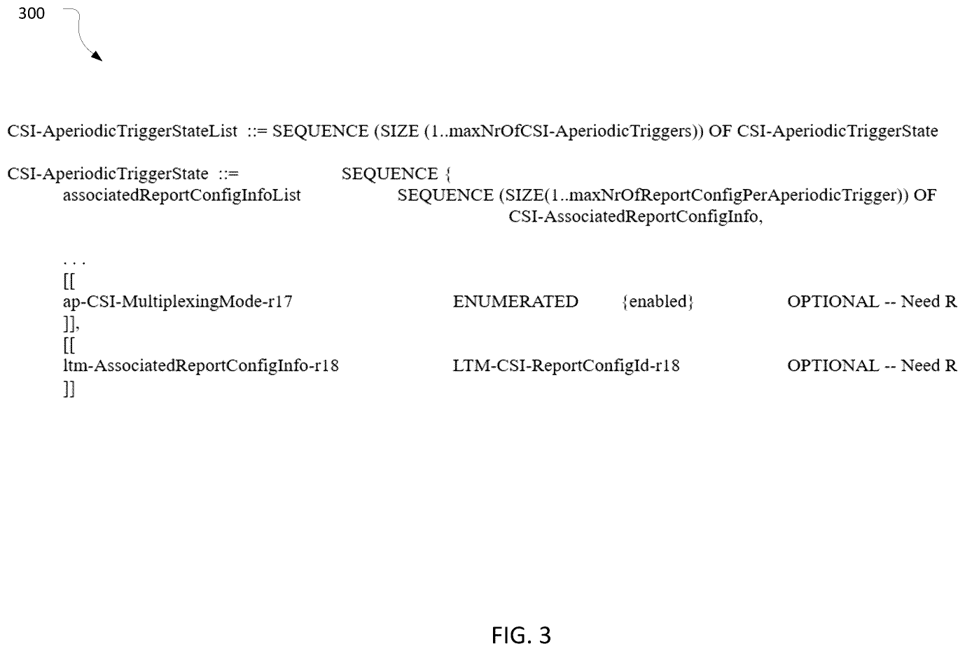

FIG. 3 illustrates an example RRC configuration 300 that may be received by the UE from the network to configure a CSI aperiodic trigger state that associates a time, frequency, and/or phase offset report and a CJT codebook report, in accordance with some embodiments.

In some embodiments, the configuration information from the network may additionally or alternatively configure the UE to apply the reported time, frequency, and/or phase offset as compensation for the CJT codebook calculation. For example, the configuration information may indicate whether the UE is to apply the reported time, frequency, and/or phase offset or use a network-configured compensation (which may be based on the reported time, frequency, and/or phase offset).

### Association Between Offset Report and Cjt Report

In some embodiments, the UE may identify an offset report (e.g., referred to as a reference offset report) and/or a set of offset values (e.g., referred to as reference offset values) to use for CJT codebook calculation based on an association between a CJT codebook report instance and an offset report. The association between the CJT codebook report and the reference offset report and/or reference offset values may be explicitly configured or based on one or more rules (e.g., predefined and/or configurable rules). The association may be used, for example, when the offset report and the CJT codebook report are transmitted at different times. The UE may use offset values from a previously transmitted offset report for calculation of CJT codebook feedback for transmission in a subsequent CJT codebook report.

In some embodiments, the reference offset report and/or the reference offset values to be used for CJT codebook calculation for a CJT codebook report may be identified based on a reference time. In a first example, the reference offset report may be the most recent offset report that is transmitted no later than the reference time (e.g., with a last symbol (end) of the offset report that is no later than the reference time).

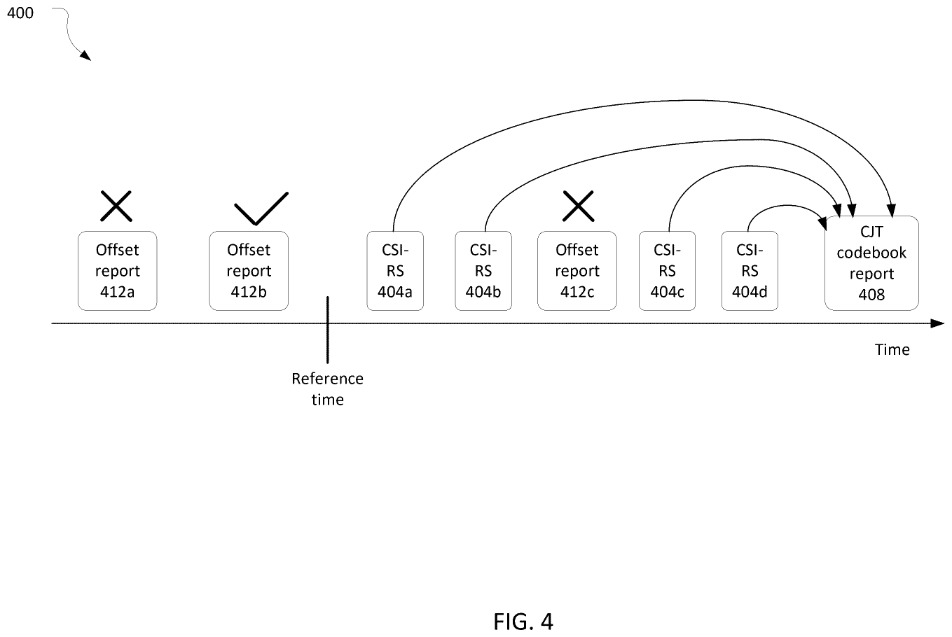

FIG. 4 illustrates an example timeline 400 of communication by a UE in accordance with the first example embodiment. As shown, the UE may receive CSI-RSs 404a-d in respective CSI-RS resources (e.g., from respective TRPs). The UE may calculate CJT codebook feedback based on the CSI-RSs 404a-d and generate CJT codebook report 408 with the CJT codebook feedback for transmission to the network.

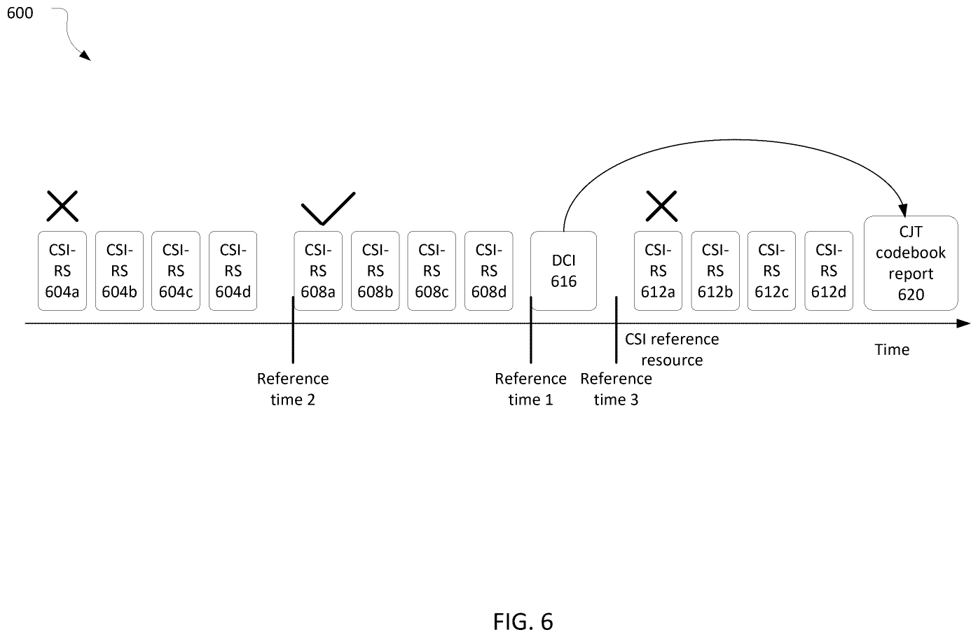

The UE may additionally transmit offset reports 412a-c. The individual offset reports 412a-c may include offset values, such as time offset, frequency offset, and/or phase offset values, for the respective TRPs. As shown in FIG. 4, the UE may identify a reference time. In some embodiments, the reference time may be at or before a beginning of the earliest CSI-RS resource of the CSI-RSs 404a-d (e.g., the beginning of CSI-RS 404a), as shown in FIG. 4. For example, the reference time may be before the beginning of the earliest CSI-RS resource by a time gap (e.g., for processing). In other embodiments, another time may be used for the reference time, e.g., as discussed further below with reference to FIG. 6.

In some embodiments, the reference offset report may be the most recent offset report that is transmitted no later than the reference time (e.g., with a last symbol (end) of the offset report that is no later than the reference time). Accordingly, in the timeline 400, the offset report 412b may be the reference offset report. The UE may calculate CJT codebook feedback based on the offset values in the offset report 412b and report the calculated CJT codebook feedback in the CJT codebook report 408.

In a second example, the UE may identify reference offset values based on the CSI-RS resources of the CSI-RSs that are measured to obtain the offset values. For example, the most recent CSI-RS resource that is measured (for the offset value) that is no later than the reference time (e.g., with a last symbol (end) of the CSI-RS resource that is no later than the reference time) may be used for a corresponding CJT codebook report. When multiple CSI-RS resources are configured for an offset report (e.g., N_{TRP} CSI-RS resources to perform offset measurements on N_{TRP} TRPs), all of the CSI-RS resources may be required to be no later than the reference time for the corresponding offset values to be used for the CJT codebook report.

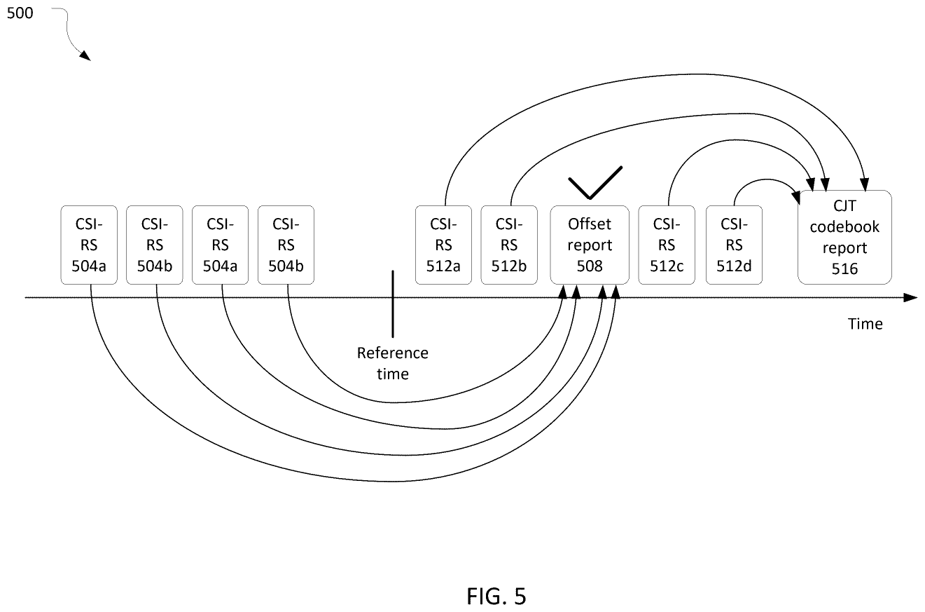

FIG. 5 illustrates an example timeline 500 of communication by a UE in accordance with the second example embodiment. As shown, the UE may receive CSI-RSs 504a-d in respective CSI-RS resources (e.g., from respective TRPs). The UE may perform offset measurements (e.g., time, frequency, and/or phase offset measurements) on the CSI-RS resources 504a-d and report the offset measurements to the network in an offset report 508.

Additionally, the UE may receive CSI-RSs 512a-d in respective CSI-RS resources (e.g., from the respective TRPs). The UE may calculate CJT codebook feedback based on the CSI-RSs 512a-d and generate CJT codebook report 516 with the CJT codebook feedback for transmission to the network.

As shown, the CSI-RSs 504a-d (on which the offset measurements are obtained) may be before the reference time, while the offset report 508 may be transmitted after the reference time (e.g., between the CSI-RS 512b and the CSI-RS 512c in the example of FIG. 5). The UE may use the offset values obtained from the CSI-RSs 504a-d to compensate the CSI-RSs 512a-d for the CJT codebook calculation since the CSI-RSs 504a-d were received before the reference time, even though the corresponding offset report 508 is transmitted after the reference time.

The scheme of timeline 500 may enable the UE to use the most recent offset values for the TRPs even if they have not yet been reported to the network. For example, in some instances there may be a delay (e.g., due to scheduling) prior to sending the offset report 508.

Various schemes may be used for defining the reference time for determination of the reference offset report and/or offset values in accordance with embodiments herein. Some examples will be described with reference to FIG. 6, which illustrates a timeline 600 of UE communication in accordance with some embodiments.

As shown in FIG. 6, the UE may receive sets of CSI-RSs 604a-d, 608a-d, and 612a-d at respective CSI-RS occasions. Within the respective sets, the CSI-RSs may be received from respective TRPs (e.g., the N_{TRP} TRPs). The UE may further receive a DCI 616 that triggers a CJT codebook report 620.

As shown, a CSI reference resource may be defined. The CSI reference resource may correspond to a latest resource in which a CSI-RS may be received to be used for the CJT codebook report 620. For example, the CSI reference resource may be as defined in 3GPP TS38.214, Section 5.2.2.5, V18.3.0 (July 3, 2024). The UE may identify the CSI-RS resources on which to perform the CJT codebook calculation for the CJT codebook report 620 as the most recent CSI-RS resources for the N_{TRP} TRPs that are at or before the CSI reference resource. Accordingly, in the timeline 600, the CSI-RSs 608a-d may be used for the CJT codebook calculation reported in CJT codebook report 620.

In a first example, the reference time (for determination of the reference offset report and/or reference offset values as discussed above) may be the first symbol of the DCI (or the physical downlink control channel (PDCCH) that includes the DCI) that triggers the CJT codebook report. The reference time in accordance with the first example is indicated as “Reference time 1”in FIG. 6.

In a second example, the reference time may correspond to the beginning of the earliest CSI-RS resource in the time domain that is used for the CJT codebook report (e.g., from among the N_{TRP} CSI-RS resources corresponding to N_{TRP} TRPs, which corresponds to CSI-RSs 608a-d in FIG. 6). For example, the reference time may be the beginning of the earliest CSI-RS resource or before the beginning of the earliest CSI-RS resource by a time gap. The reference time in accordance with the second example is indicated as “Reference time 2” in FIG. 6.

In a third example, the reference time may be the CSI reference resource for the CJT codebook report 620. The reference time in accordance with the third example is indicated as “Reference time 3” in FIG. 6.

In various embodiments, the UE may support one or more of the techniques for enhanced CJT codebook with offset compensation as described herein. For example, the UE may support one or more of: a first mode in which the network explicitly configures the offset values to use for compensation for respective TRPs; a second mode in which the network triggers the UE to report the offset values together with the enhanced CJT codebook (with the reported offset values used to compensate the respective TRPs for the CJT codebook calculation); and/or a third mode in which the UE may transmit an offset report separately from the enhanced CJT codebook and use the reported offset values for compensation when calculating the enhanced CJT codebook.

The third mode may require the UE to store the offset values after they have been reported to the network, while the first mode and the second mode may not require the UE to store the offset values after they have been reported to the network (e.g., the UE may discard the offset values after transmitting the associated offset report). Accordingly, a future 3GPP specification may require UEs to support one or both of the first mode or the second mode to support enhanced CJT codebook (the third mode may or may not be supported as an optional feature).

In some embodiments, the UE may transmit UE assistance information to the network to indicate one or more modes that are supported by the UE for enhanced CJT codebook reporting (e.g., the first, second, and/or third modes described above).

### Example Operation Flow/Algorithmic Structures

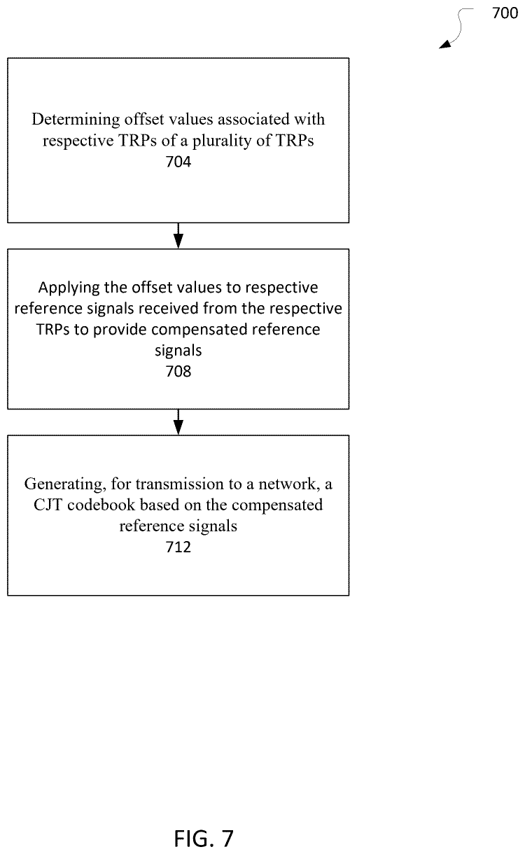

FIG. 7 illustrates an operation flow/algorithmic structure 700 in accordance with some embodiments. The operation flow/algorithmic structure 700 may be performed by a UE, such as UE 104, UE 1000, or components therein, for example, baseband processor 1004A.

The operation flow/algorithmic structure 700 may include, at 704, determining offset values associated with respective TRPs of a plurality of TRPs. The offset values may include, for example, a time (delay) offset, a frequency offset, and/or a phase offset for the respective TRPs.

The operation flow/algorithmic structure 700 may further include, at 708, applying the offset values to respective reference signals received from the respective TRPs to provide compensated reference signals. For example, applying the offset values may include applying a time offset, frequency offset, and/or phase offset. The offset values may be applied in the time domain and/or the frequency domain.

The operation flow/algorithmic structure 700 may further include, at 712, generating, for transmission to a network, a CJT codebook based on the compensated reference signals. The CJT codebook may be a Type II codebook. The CJT codebook may include precoding information, such as a precoding matrix and/or PMI.

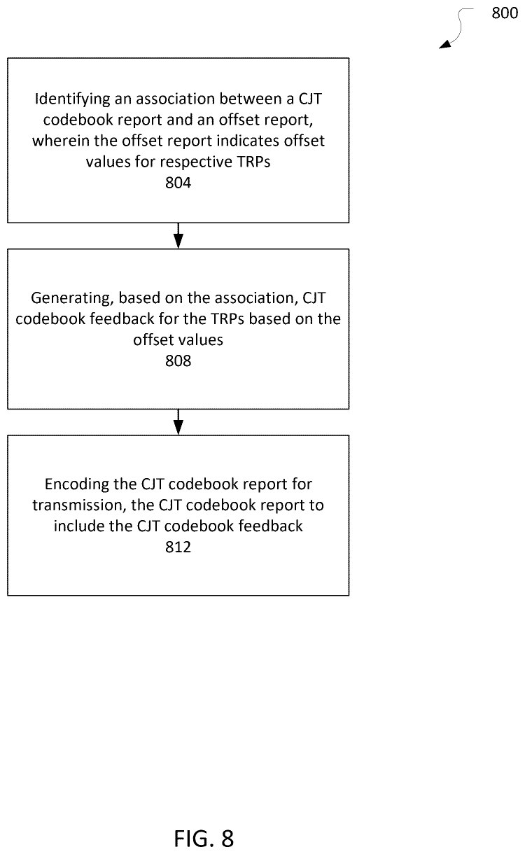

FIG. 8 illustrates another operation flow/algorithmic structure 800 in accordance with some embodiments. The operation flow/algorithmic structure 800 may be performed by a UE, such as UE 104, UE 1000, or components therein, for example, baseband processor 1004A.

The operation flow/algorithmic structure 800 may include, at 804, identify an association between a CJT codebook report and an offset report, wherein the offset report indicates offset values for respective TRPs. The offset values may include, for example, a time (delay) offset, a frequency offset, and/or a phase offset for the respective TRPs.

The operation flow/algorithmic structure 800 may further include, at 808, generating, based on the association, CJT codebook feedback for the TRPs based on the offset values. Generating the CJT codebook feedback may include, for example, applying the offset values to respective reference signals received from the respective TRPs to provide compensated reference signals, and performing a CJT codebook calculation on the compensated reference signals to generate the CJT codebook feedback. The offset values may be applied in the time domain and/or the frequency domain.

The operation flow/algorithmic structure 800 may further include, at 812, encoding the CJT codebook report for transmission, the CJT codebook report to include the CJT codebook feedback. In some embodiments, the UE may receive a DCI to trigger the CJT codebook report (e.g., aperiodic CJT codebook report).

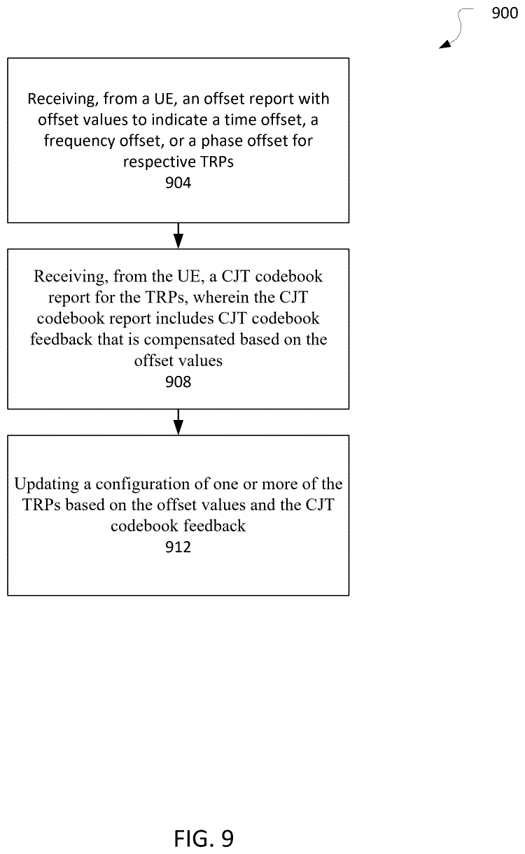

FIG. 9 illustrates another operation flow/algorithmic structure 900 in accordance with some embodiments. The operation flow/algorithmic structure 900 may be performed by a network device, such as an access node (e.g., access node 116), base station (e.g., base station 108), TRP (e.g., TRP 112), and/or network device 1100, or components therein, for example, baseband processor 1104A.

The operation flow/algorithmic structure 900 may include, at 904, receiving, from a UE, an offset report with offset values to indicate a time offset, a frequency offset, or a phase offset for respective TRPs.

The operation flow/algorithmic structure 900 may further include, at 908, receiving, from the UE, a CJT codebook report for the TRPs, wherein the CJT codebook report includes CJT codebook feedback that is compensated based on the offset values. The CJT codebook report may include precoding information, such as one or more precoding matrices and/or PMIs.

The operation flow/algorithmic structure 900 may further include, at 912, updating a configuration of one or more of the TRPs based on the offset values and the CJT codebook feedback. For example, the configuration may include a precoding configuration and/or a configuration to compensate for the time, frequency, and/or phase offset.

### Example Devices

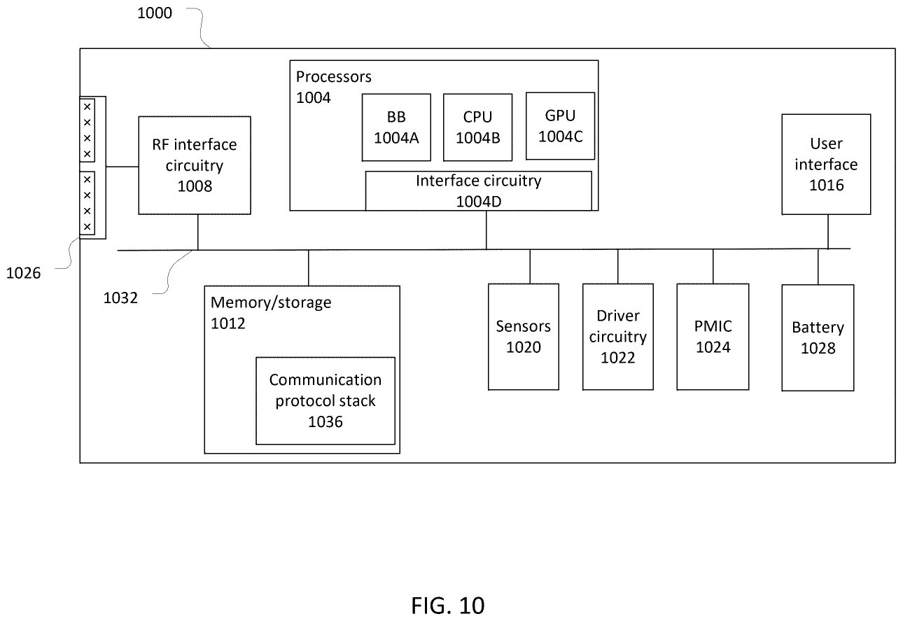

FIG. 10 illustrates a UE 1000 in accordance with some embodiments. The UE 1000 may be similar to and substantially interchangeable with UE 104.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1000 may include processors 1004, RF interface circuitry 1008, memory/storage 1012, user interface 1016, sensors 1020, driver circuitry 1022, power management integrated circuit (PMIC) 1024, antenna 1026, and battery 1028. The components of the UE 1000 may be implemented as integrated circuits (ICs), portions thereof, discrete electronic devices, or other modules, logic, hardware, software, firmware, or a combination thereof. In an example, one or more of processor 1004 may include the RF interface circuitry 1008. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform CJT codebook reporting as described herein. The processors 1004 may also include interface circuitry 1004D to enable communication by, for example, communicatively coupling the processor circuitry with one or more other components of the UE 1000.

In some embodiments, the baseband processor 1004A may access a communication protocol stack 1036 in the memory/storage 1012 to communicate over a 3GPP compatible network. In general, the baseband processor 1004A may access the communication protocol stack 1036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform CJT codebook reporting as described herein.

The memory/storage 1012 includes any type of volatile or non-volatile memory that may be distributed throughout the UE 1000. In some embodiments, some of the memory/storage 1012 may be located on the processors 1004 themselves (for example, memory/storage 1012 may be part of a chipset that corresponds to the baseband processor 1004A), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

A battery 1028 may power the UE 1000, although in some examples the UE 1000 may be mounted deployed in a fixed location and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

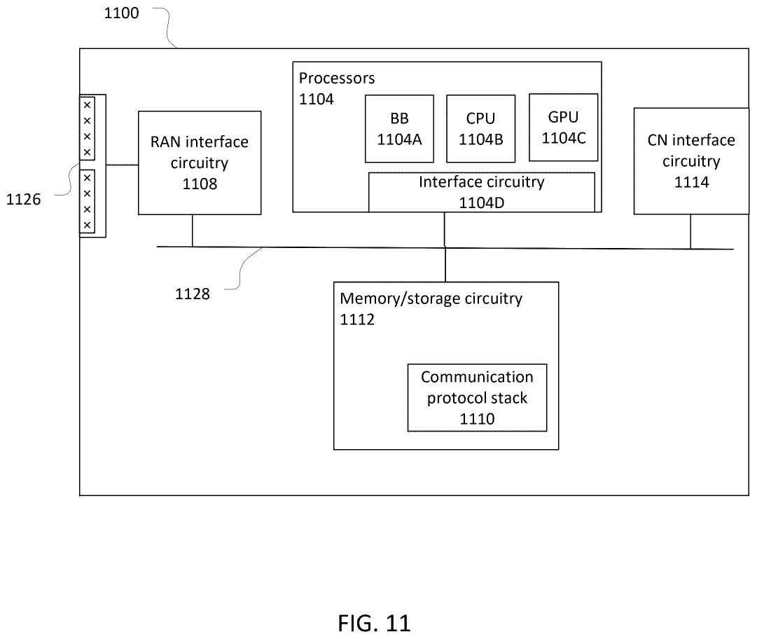

FIG. 11 illustrates a network device 1100 in accordance with some embodiments. The network device 1100 may be similar to, and substantially interchangeable with access node 116, base station 108, and/or TRPs 112.

The network device 1100 may include processors 1104, RF interface circuitry 1108 (if implemented as a base station), core network (CN) interface circuitry 1114, memory/storage circuitry 1112, and antenna structure 1126.

The components of the network device 1100 may be coupled with various other components over one or more interconnects 1128.

The processors 1104, RF interface circuitry 1108, memory/storage circuitry 1112 (including communication protocol stack 1110), antenna structure 1126, and interconnects 1128 may be similar to like-named elements shown and described with respect to FIG. 10.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage circuitry 1112 to cause the network device 1100 to perform operations associated with CJT codebook reporting as described herein. The processors 1104 may also include interface circuitry 1104D to communicatively couple the processor circuitry with one or more other components of the network device 1100.

The CN interface circuitry 1114 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1100 via a fiber optic or wireless backhaul. The CN interface circuitry 1114 may include one or more dedicated processors or FPGAs to communicate using one or more of the aforementioned protocols. In some implementations, the CN interface circuitry 1114 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: determining offset values associated with respective transmission-reception points (TRPs) of a plurality of TRPs; applying the offset values to respective reference signals received from the respective TRPs to provide compensated reference signals; and generating, for transmission to a network, a coherent joint transmission (CJT) codebook based on the compensated reference signals.

Example 2 includes the method of example 1 or some other example herein, wherein the CJT codebook includes a suggested precoding matrix indicator for CJT with the plurality of TRPs.

Example 3 includes the method of example 1 or some other example herein, wherein the offset values include a time offset, a frequency offset, or a phase offset.

Example 4 includes the method of example 1 or some other example herein, wherein determining the offset values includes determining the offset values based on respective offset measurements for the plurality of TRPs.

Example 5 includes the method of example 4 or some other example herein, wherein generating the CJT codebook for transmission includes generating a report for transmission that includes the CJT codebook and the determined offset values.

Example 6 includes the method of example 4 or some other example herein, further comprising generating an offset report for transmission to the network prior to transmission of a CJT codebook report that includes the CJT codebook.

Example 7 includes the method of example 1 or some other example herein, wherein determining the offset values includes receiving the offset values from the network.

Example 8 includes the method of example 1 or some other example herein, further comprising receiving a downlink control information (DCI) to trigger reporting of the CJT codebook and the offset values.

Example 9 includes the method of example 1 or some other example herein, wherein the reference signals include aperiodic channel state information—reference signals (CSI-RSs).

Example 10 includes an apparatus comprising processing circuitry to: identify an association between a coherent joint transmission (CJT) codebook report and an offset report, wherein the offset report indicates offset values for respective transmission-reception points (TRPs); generate, based on the association, CJT codebook feedback for the TRPs based on the offset values; and encode the CJT codebook report for transmission, the CJT codebook report to include the CJT codebook feedback. The apparatus of example 10 further comprises interface circuitry coupled to the processing circuitry to enable communication.

Example 11 includes the apparatus of example 10 or some other example herein, wherein the association is identified based on a reference time.

Example 12 includes the apparatus of example 11 or some other example herein, wherein to identify the association includes to identify the offset report as associated with the CJT codebook report based on the offset report being transmitted no later than the reference time.

Example 13 includes the apparatus of example 11 or some other example herein, wherein the processing circuitry is further to obtain the offset values on respective reference signals received from the TRPs, and wherein to identify the association includes to identify the offset report as associated with the CJT codebook report based on the reference signals being no later than the reference time.

Example 14 includes the apparatus of example 11 or some other example herein, wherein the CJT codebook feedback is generated based on channel state information—reference signals (CSI-RSs) received from the respective TRPs, and wherein the reference time corresponds to a beginning of an earliest CSI-RS resource in which one of the CSI-RSs is received.

Example 15 includes the apparatus of example 11 or some other example herein, wherein the reference time corresponds to an earliest symbol of a downlink control information (DCI) that triggers the CJT codebook report.

Example 16 includes the apparatus of example 11 or some other example herein, wherein the reference time corresponds to a channel state information (CSI) reference resource.

Example 17 includes the apparatus of example 10 or some other example herein, wherein the processing circuitry is further to encode, for transmission to a network, user equipment (UE) capability information to indicate support for reporting the offset values separately from the CJT codebook report.

Example 18 includes the apparatus of example 10 or some other example herein, wherein the offset values include a time offset, a frequency offset, or a phase offset.

Example 19 includes a method comprising: receiving, from a user equipment (UE), an offset report with offset values to indicate a time offset, a frequency offset, or a phase offset for respective transmission-reception points (TRPs); receiving, from the UE, a coherent joint transmission (CJT) codebook report for the TRPs, wherein the CJT codebook report includes CJT codebook feedback that is compensated based on the offset values; and updating a configuration of one or more of the TRPs based on the offset values and the CJT codebook feedback.

Example 20 includes the method of example 19 or some other example herein, further comprising: encoding, for transmission to the UE, configuration information to configure a channel state information (CSI) aperiodic trigger state that associates the offset report and the CJT codebook report; and encoding a downlink control information (DCI) for transmission to the UE with the CSI aperiodic trigger state to trigger the offset report and the CJT codebook report.

Example 21 includes the method of example 19 or some other example herein, wherein the offset report and the CJT codebook report are included in a same report.

Example 22 includes the method of example 19 or some other example herein, further comprising sending a message to the UE to indicate the offset values for the CJT codebook report.

Example 23 includes the method of example 19 or some other example herein, further comprising receiving, from the UE, capability information to indicate that the UE supports transmitting the offset report separately from the CJT codebook report and using the offset values for generating the CJT codebook feedback.

Another example may include an apparatus comprising means to perform one or more elements of a method described in or related to any of examples 1-23, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-23, or any other method or process described herein.

Another example may include an apparatus comprising logic, modules, or circuitry to perform one or more elements of a method described in or related to any of examples 1-23, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example may include a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
processing circuitry to:
identify an association between a coherent joint transmission (CJT) codebook report and an offset report, wherein the offset report indicates offset values corresponding to respective channel state information-reference signal (CSI-RS) resources;
generate, in accordance with the association, CJT codebook feedback based on the offset values; and
encode the CJT codebook report for transmission, the CJT codebook report to include the CJT codebook feedback; and
interface circuitry coupled to the processing circuitry to enable communication.

2. The apparatus of claim 1, wherein the association is identified based on a reference time.

3. The apparatus of claim 2, wherein to identify the association includes to identify the offset report as associated with the CJT codebook report based on the offset report being transmitted no later than the reference time.

4. The apparatus of claim 2, wherein to identify the association includes to identify the offset report as associated with the CJT codebook report based on the CSI-RS resources being no later than the reference time.

5. The apparatus of claim 2, wherein the reference time corresponds to an earliest symbol of a downlink control information (DCI) that triggers the CJT codebook report.

6. The apparatus of claim 1, wherein the CSI-RS resources correspond to different transmission-reception points (TRPs).

7. The apparatus of claim 1, wherein the processing circuitry is further to encode, for transmission to a network, user equipment (UE) capability information to indicate support for reporting the offset values separately from the CJT codebook report.

8. The apparatus of claim 1, wherein the offset values include a time offset, a frequency offset, or a phase offset.

9. A method comprising:
receiving, from a user equipment (UE), an offset report with offset values to indicate a time offset, a frequency offset, or a phase offset corresponding to respective channel state information (CSI)-reference signal (RS) resources;
receiving, from the UE, a coherent joint transmission (CJT) codebook report, wherein the CJT codebook report includes CJT codebook feedback that is compensated based on the offset values; and
updating a configuration for CJT with the UE based on the offset values and the CJT codebook feedback.

10. The method of claim 9, further comprising:
encoding, for transmission to the UE, configuration information to configure a CSI aperiodic trigger state that associates the offset report and the CJT codebook report; and
encoding a downlink control information (DCI) for transmission to the UE with the CSI aperiodic trigger state to trigger the offset report and the CJT codebook report.

11. The method of claim 9, wherein the offset report and the CJT codebook report are included in a same report.

12. The method of claim 9, further comprising receiving, from the UE, capability information to indicate that the UE supports transmitting the offset report separately from the CJT codebook report and using the offset values for generating the CJT codebook feedback.

13. The method of claim 9, further comprising:
generating, for transmission to the UE, a downlink control information (DCI) to trigger the CJT codebook report; and
identifying that the offset report is associated with the CJT codebook report based on a reference time that corresponds to a first symbol of the DCI.

14. The method of claim 13, wherein identifying that the offset report is associated with the CJT codebook report is further based on the offset report being received prior to the reference time.

15. The method of claim 9, wherein the CSI-RS resources correspond to different transmission-reception points (TRPs).

16. A method comprising:
determining offset values associated with respective transmission-reception points (TRPs) of a plurality of TRPs; and
generating, for transmission to a network, a coherent joint transmission (CJT) codebook based on the offset values and respective reference signals received from the plurality of TRPs.

17. The method of claim 16, wherein the offset values include a time offset, a frequency offset, or a phase offset.

18. The method of claim 16, further comprising receiving a downlink control information (DCI) to jointly trigger reporting of the CJT codebook and the offset values, wherein generating the CJT codebook for transmission includes generating a report for transmission that includes the CJT codebook and the determined offset values.

19. The method of claim 16, wherein generating the CJT codebook for transmission includes generating a CJT codebook report for transmission that includes the CJT codebook, and wherein the method further comprises generating an offset report for transmission to the network prior to transmission of the CJT codebook report, the offset report including the offset values.

20. The method of claim 19, further comprising identifying an association between the offset report and the CJT codebook report based on the offset report being transmitted prior to receiving a downlink control information (DCI) that triggers the CJT codebook report, wherein the CJT codebook is generated based on the offset values in accordance with the association.
